(19) United States
(12) Patent Application Publication
(10) Pub. No.: US 2004/0205269 A1
(43) Pub. Date: Oct. 14, 2004

(54) Method and apparatus for synchronizing data from asynchronous disk drive data transfers

(75) Inventor: Michael C. Stolowitz, Danville, CA (US)

Correspondence Address: STOEL RIVES LLP, 900 SW FIFTH AVENUE, SUITE 2600, PORTLAND, OR, 97204, US

(73) Assignee: NetCell Corp., San Jose, CA

(21) Appl. No.: 10/822,115

(22) Filed: Apr. 8, 2004

Related U.S. Application Data
(60) Provisional application No. 60/461,445, filed on Apr. 9, 2003.

(51) Int. Cl. G06F 3/00

(52) U.S. Cl. 710/52

(57) ABSTRACT

Method and apparatus to effect synchronous data transfers in a disk controller, for example to and from a common buffer (52), when the data transfers to and from the individual disk drives (12,20) are actually asynchronous. A FIFO memory (26,28) is provided in the controller for each disk drive. Asynchronous data transfers between each drive and the corresponding FIFO use the timing provided by the respective drive (interfaces 16,24); whereas data transfers on the buffer side of the FIFOs (46,48) are effected synchronously (44,72). The availability of synchronous data transfers enables “on the fly” generation of redundancy information (FIG. 3) (in the disk write direction) and “on the fly” regeneration of missing data in the read direction (FIG. 4).

### RELATED APPLICATIONS

This application is a continuation of and claims priority from U.S. provisional application No. 60/461,445 filed Apr. 9, 2003.

### COPYRIGHT NOTICE

© 2003-2004 Netcell Corp. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

The invention lies in the broad field of ELECTRICAL COMPUTERS AND DIGITAL DATA PROCESSING SYSTEMS and, more specifically, pertains to disk array controllers.

### BACKGROUND OF THE INVENTION

Disk drives are well known for digital data storage and retrieval. It is also increasingly common to deploy two or more drives, called an array of drives, coupled to a single computer. Through the use of the method described in U.S. Pat. No. 6,018,778 data may be accessed synchronously from an array of IDE drives. U.S. Pat. No. 6,018,778 is hereby incorporated herein. This synchronous access required the use of a common strobe or other clocking source from the controller. This was compatible with Programmed IO (PIO) data transfers at rates up to 16 MBPS.

Various disk drive interfaces and protocols have evolved over time. The IDE drive interface, for example, is defined by the ATA/ATAPI specification from NCITS. In 1997, there was a proposal for an Ultra DMA protocol, “UDMA”. Use of this new protocol with the existing electrical interface doubled the data transfer rate up to 33 MBPS. Subsequent enhancements that included the use of improved electrical drivers, receivers, and cables, have pushed the transfer rates to over 100 MBPS.

One of the characteristics of some newer protocols is that the data strobe comes from the same end of the cable as the data. For a disk write, both the strobe and data originate in the controller as they had with Programmed IO (PIO). For a disk read, both the strobe and the data come from the drive to the controller. When an array of disks is read using this type of protocol, the strobes are all asynchronous making the synchronous data transfer described in U.S. Pat. No. 6,018,778 impossible.

What is needed is a method and apparatus to effect synchronous data transfers, for example to and from a buffer, when the data transfers to and from the disk drives are actually asynchronous. The availability of synchronous data transfers would enable “on the fly” generation of redundancy information (in the disk write direction) and “on the fly” regeneration of missing data in the read direction (in the event of a disk failure) using the method as described in U.S. Pat. No. 6,237,052. U.S. Pat. No. 6,237,052 is hereby incorporated herein.

### SUMMARY OF THE INVENTION

The present invention is directed in part to creating synchronous data transfers in a disk controller where the actual data transfers to and from the disk drives are asynchronous in that, for some interfaces and protocols, the disk transfer operations are paced not by the disk controller, but by the individual drive electronics, and each drive completes its part of a given operation, for example a read or write of striped data, at a different time. The availability of synchronous data transfers enables “on the fly” generation of redundancy information (in the disk write direction) and “on the fly” regeneration of missing data in the read direction (in the event of a disk failure).

In one embodiment, the current invention introduces an elastic buffer, i.e. a FIFO, into the data path of each of the drives and the controller. This strategy is illustrated with the case of a UDMA interface, although it can be used in any application where a data strobe originates at the data storage device rather than the controller. Consider first the Disk Read operation. For each of the drives and its FIFO, an interface implementing the UMDA protocol accepts data from the drive and pushes it into the FIFO on the drive's read strobe. Should any of the FIFOs approach full, the interface will “pause” the data transfer using the mechanism provided in the UDMA protocol. For this purpose, the FIFO shall provide an “almost full” signal that is asserted with enough space remaining in the FIFO to accept the maximum number of words that a drive may send once “pause” has been asserted. Data is removed from the FIFOs synchronously using most of the steps of the method described in U.S. Pat. No. 6,018,778.

Specifically, after issuing read commands to all of the drives, we wait until there is data available for transfer in all of the FIFOs, i.e. that they are all indicating a “not empty” condition. The data is then taken with a common read strobe and transferred to a buffer memory within the controller using a single address counter. Should any of the FIFOs become “empty”, the process will stall until they all indicate “not empty” once again.

Consider now the disk write direction. Once again, a FIFO is introduced in the data path between the controller and each of the drives. Data is read from a buffer within the controller using a single address counter. Segments of the data words read from the buffer are pushed into each of the FIFOs using a common strobe, i.e. the data is striped over the drives of the array. Should any of the FIFOs become “full” the process is stalled. On the drive side of the FIFO, interfaces implementing the UDMA protocol will pop data from the FIFOs and transfer it to the drives. While these transfers might start simultaneously, they will not be synchronous as each of the interfaces will respond independently to “pause” and “stop” requests from its attached drive.

This adaptation of disk drive interfaces or protocols that are asynchronous, in the sense that the drive generates its data strobe, to enable synchronous redundant data transfers through the use of FIFOs or similar memory provides a significant advantage over the standard techniques for handling concurrent data transfer requests from an array of drives.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified schematic diagram of a disk array system showing read data paths for synchronizing UDMA data.

FIG. 2 is a simplified schematic diagram of a disk array system showing write data paths for writing to UDMA drives.

FIG. 3 is a simplified schematic diagram of a disk array write data path with “on the fly” redundant data storage.

FIG. 4 is a simplified schematic diagram of a disk array read data path with “on the fly” regeneration of data with one drive failed.

FIG. 5 is a timing diagram illustrating a disk array READ operation.

### DETAILED DESCRIPTION OF PREFERRED EMBODIMENTS

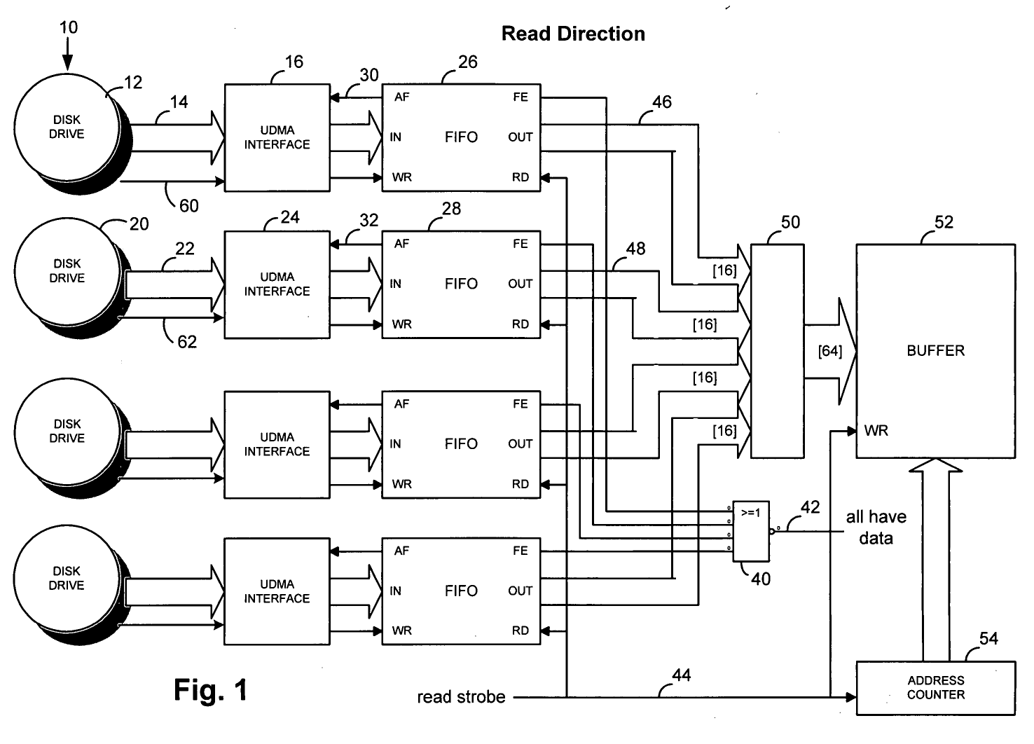

FIG. 1 illustrates an array 10 of disk drives. The UDMA protocol is used by way of illustration and not limitation. Drive 12 has a data path 14 to provide read data to an interface 16 that implements the standard UDMA protocol. Similarly, a second drive 20 had a data path 22 coupled to a corresponding UDMA interface 24, and so on. The number of drives may vary; four are shown for illustration. Each physical drive is attached to a UDMA interface. Each drive is coupled via its UDMA interface to a data input port of a memory such as a FIFO, although other types of memories can be used. For example, disk drive 12 is coupled via UDMA interface 16 to a first FIFO 26, while disk drive 20 is coupled via its UDMA interface 24 to a second FIFO 28 and so on.

In each case, the UDMA interface accepts data from the drive and pushes it into the FIFO on the drive's read strobe. See signal 60 from drive 12 to FIFO 26 write WR input; signal 62 from drive 20 to FIFO 28 write WR input, and so on.

As noted above, this strategy is contrary to the PIO mode where the read strobe is provided to the drive by the controller. Should any of the FIFOs approach a full condition, the UDMA interface will “pause” by the method described in the ATA/ATAPI specification from NCITS. For this purpose, the FIFO or other memory system provides an “almost full” (“AF”) signal 30, 32 that is asserted while enough space still remains available in the FIFO to accept the maximum number of words that a drive may send once “pause” has been asserted.

Data is removed from the FlFOs synchronously using a method similar to that described in U.S. Pat. No. 6,018,778. Specifically, after issuing read commands to all of the drives, we wait until there is data available for transfer in all of the FIFOs, i.e. that they are all indicating a “not empty” condition. This is illustrated in FIG. 1 by signals FE from each FIFO, input to a logic block 40 to generate the “all [FIFOs] have data” signal 42. After an indication that all FIFOS have data; i.e. all of the FIFOs have data from their corresponding drives, the read data is transferred.

The read data is transferred as follows. Each FIFO has a data output path, for example 46, 48 -sixteen bits wide in the presently preferred embodiment. All of the drive data paths are merged, as indicated at box 50, in parallel fashion. In other words, a “broadside” data path is provided from the FIFOs to a buffer 52 that has a width equal to N times m bits, where N is the number of attached drives and m is the width of the data path from each drive (although they need not necessarily all have the same width) In the illustrated configuration, four drives are in use, each having a 16-bit data path, for a total of 64 bits into buffer 52 at one time.

The transfer of data from the FIFOs is driven by a common read strobe 44 broadcast to all of the FIFOs. The transfer into buffer 52 thus is made synchronously, using a single address counter 54 as shown, even though each of the drives is providing a portion of the read data asynchronously. Should any of the FIFOs become “empty”, the process will stall until they all indicate “not empty” once again.

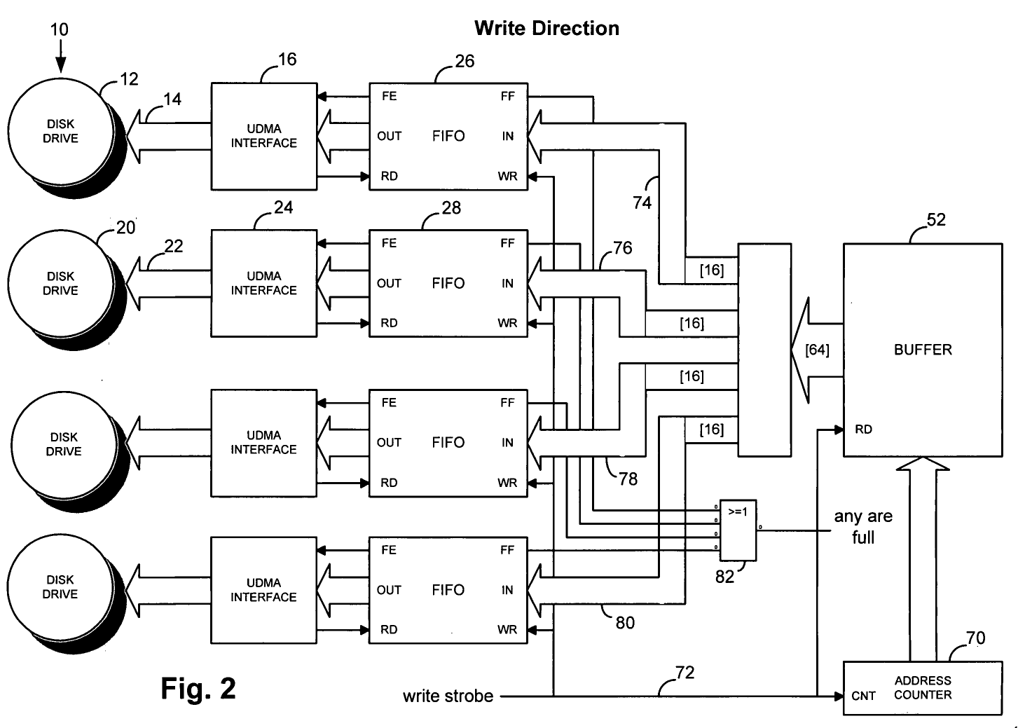

Referring now to FIG. 2, we describe the disk write operation. Once again, a FIFO is introduced in the data path between the controller and each of the drives. Data is read from the buffer 52 within the controller using a single address counter 70. In a presently preferred embodiment, since the drive to buffer data transfers are half-duplex, the FIFOs and address counters may be shared. Each FIFO has multiplexers (not shown) for exchanging its input and output ports depending on the data transfer direction.

Segments of the data words read from the buffer are pushed into each of the FIFOs using a common strobe 72, coupled to the write control input WR of each FIFO as illustrated. See data paths 74, 76, 78, 80. In this way, the write data is “striped” over the drives of the array. Should any of the FIFOs become “full” the process is stalled. This is implemented by the logic represented by block 82 generating the “any are full” signal.

On the drive side of the FIFOs, interfaces 16, 24 etc. implementing the UDMA protocol will pop data from the FIFOs and transfer it to the drives. While these transfers might start simultaneously, they will not be synchronous as each of the interfaces will respond independently to “pause” and “stop” requests from its drive.

This adaptation of UDMA to enable synchronous redundant data transfers through the use of FIFOs provides a significant advantage over the standard techniques for handling concurrent data transfer requests from an array of drives. The standard approach requires a DMA Channel per drive, i.e. more than one address counter. These DMA Channels contend for access to the buffer producing multiple short burst transfers and lowering the bandwidth achievable from the various DRAM technologies. We have determined that the buffer bandwidth due to the combination Disk Data Transfers, Host Data Transfers, and accesses for Redundant Data Computations becomes a bottleneck for most of the RAID controller designs. As noted above, the present invention requires only a single DMA channel for the entire array.

Data stored in a disk array may be protected from loss due to the failure of any single drive by providing redundant information. In a redundant array, stored data includes user data as well as redundant data sufficient to enable reconstruction of all of the user data in the event of a failure of any single drive of the array.

U.S. Pat. No. 6,237,052 B1 teaches that redundant data computations may be performed “On-The-Fly” during a synchronous data transfer. The combination of the three concepts: Synchronous Data Transfers, “On-The-Fly” redundancy, and the UDMA adapter using a FIFO per drive provides a high performance redundant disk array data path using a minimum of hardware.

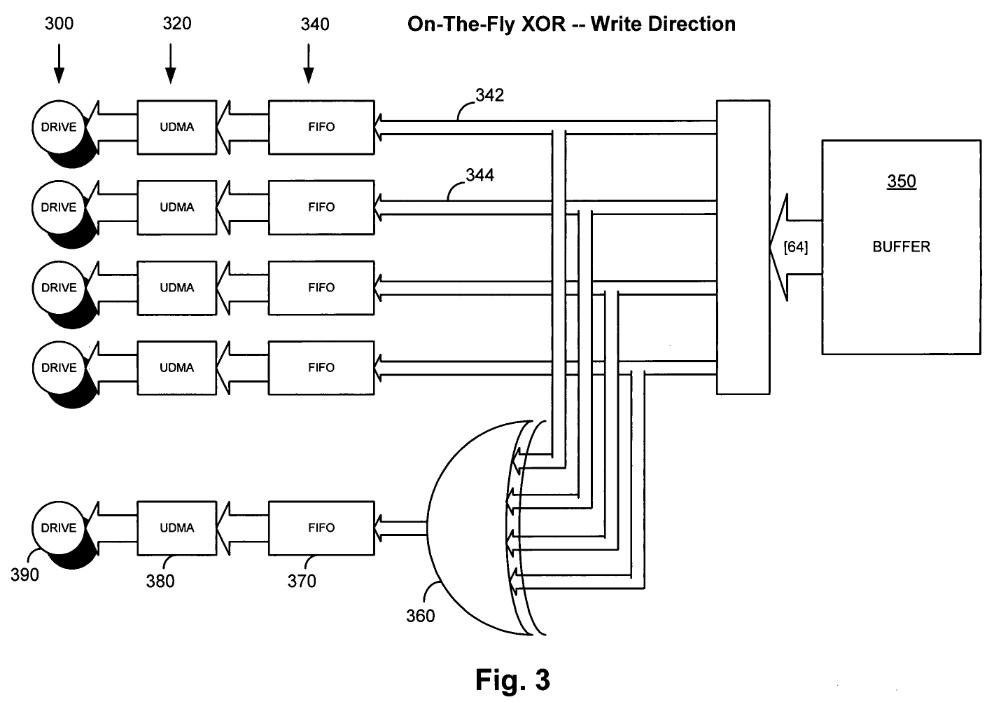

While various arithmetic and logical operations might be used to generate a redundant data pattern, the XOR shall used in the current explanation. Referring now to FIG. 3, data flow in the write direction is shown. The drawing illustrates a series of drives 300, each connected to a corresponding one of a series of UDMA interfaces 320. Each drive has a corresponding FIFO 340 in the data path as before.

In the Disk Write direction, data words are read from the buffer 350. Segments of these data words, e.g. see data paths 342, 344, are written to each of the drives. At this point, a logical XOR operation can be performed between the corresponding bits of the segments “on the fly”. XOR logic 360 is arranged to compute the boolean XOR of the-corresponding bits of each segment, producing a sequence of redundant segments that are stored preliminarily in a FIFO 370, before transfer via UDMA interface 380 to a redundant or parity drive 390. Thus the XOR data is stored synchronously with the data segments. In other words, “On-The-Fly” generation of a redundant data pattern “snoops” the disk write process without adding any delays to it.

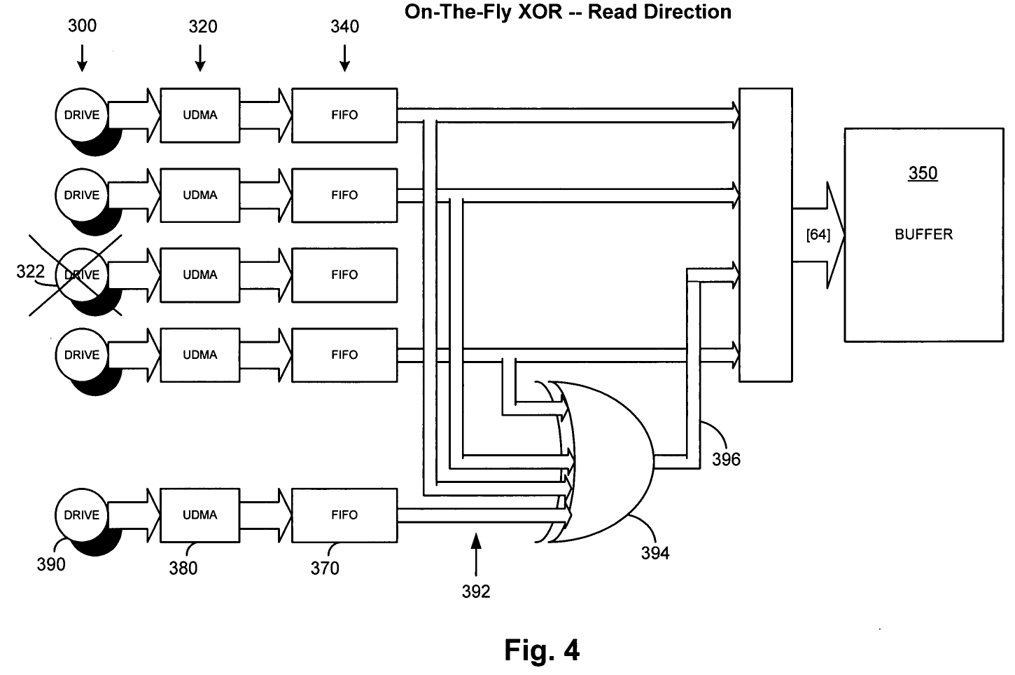

Turning now to FIG. 4 in the drawing, a similar diagram illustrates data flow in the read direction. The array of drives 300, corresponding interfaces 320 and FIFO memories 340 are shown as before. In the Disk Read direction, the XOR is computed across the data segments read from each of the data drives and the redundant drive. Thus, the data segments are input via paths 392 to XOR logic 394 to produce XOR output at 396. If one of the data drives has failed (drive 322 in FIG. 4), the result of the XOR computation at 394 will be the original sequence of segments that were stored on the now failed drive 322. This sequence of segments is substituted for the now absent sequence from the failed drive and stored along with the other data in the buffer 350. This substitution can be effected by appropriate adjustments to the data path. This data reconstruction does not delay the data transfer to the buffer, as more fully explained in my previous patents.

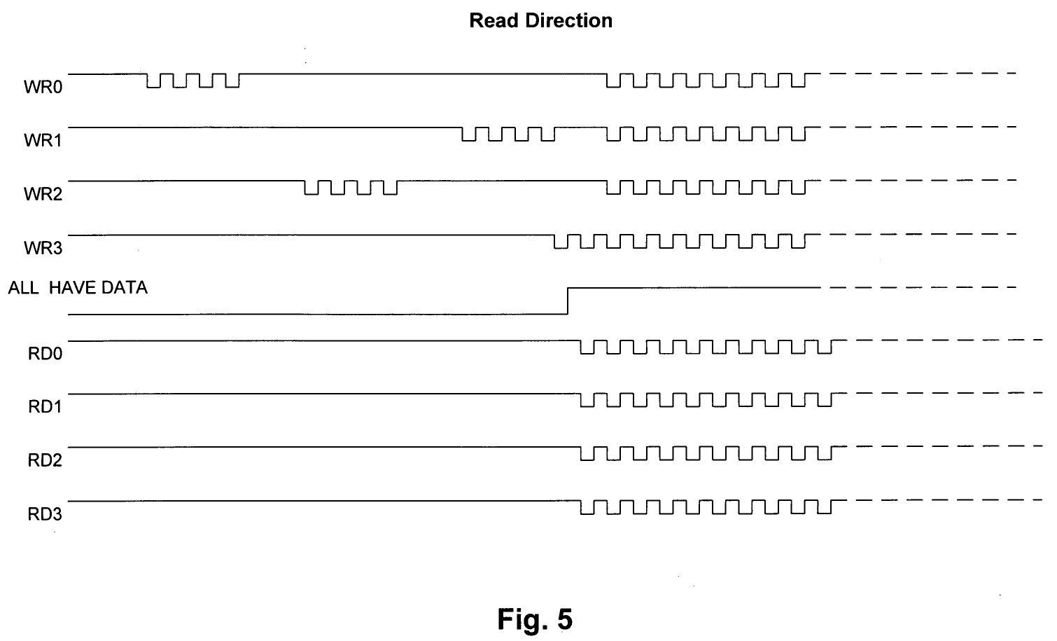

FIG. 5 is a timing diagram illustrating FIFO related signals in the disk read direction in accordance with the invention. As indicated, each drive is likely to have a different read access time. Once a drive has the target data in its local buffer, it asserts DMARQ (a DMA request). Next, upon receiving DMACK, it begins its data transfer into the FIFO. In the figure, Drive 0 happens to finish first and transfers data until it fills the FIFO. It is followed by Drives 2, 1, and 3 in that order. In this case, Drive 3 happened to be last. Once it begins to write the FIFO, all four FIFOs will be not empty allowing data to be removed synchronously from all four FIFOs with a common strobe, shown here as independent RD0-RD3 to emphasize that they are in fact synchronous.

In the prior art, the protection of data through the storage of redundant information has been a major part of the problem that they were trying to solve. For a Disk Read, many of the controllers have to wait until the data has been collected in the buffer. At this point, the data would be read from the buffer, the XOR computed, and the result put back. Given that there are still both host and disk accesses of the buffer, the access for the purpose of computing an XOR is a third access adding 50% to the bandwidth requirements of the buffer. The read/modify/write operations required by a local processor to perform this task were too slow, so specialized DMA hardware engines have been designed for this process. The time required to compute the XOR is reduced, but a third pass over the data in the buffer is still required.

In many of the implementations, new data is written to the disk immediately. The writes to the parity drive must be postponed until the XOR computation has been completed. These write backs accumulate and the parity drive becomes a bottleneck for write operations. Many designs try to solve this problem by distributing the parity over all of the drives of the array in RAID 5. Another approach used in the prior art is an attempt to compute the redundancy as data is transferred from the host or to the drives. Since these transfers occur at different times, the “accumulator” for the intermediate results is a full sector or more of data. This avoids the need for additional buffer accesses, but at the cost of greatly increased complexity.

As noted above, the current invention does not require 50% more buffer bandwidth for XOR computation accesses, or buffer space to store redundant data, or specialized DMA engines to perform read/modify/write operations against the buffer contents, or specialized buffers to store intermediate results from XOR computations.

In one embodiment, a disk array controller in accordance with the invention is implemented on a computer motherboard. It can also be implemented as a Host Bus Adapter (HBA), for example, to interface with a PCI host bus.

It will be obvious to those having skill in the art that many changes may be made to the details of the above-described embodiments without departing from the underlying principles of the invention. The scope of the present invention should, therefore, be determined only by the following claims.

1. A method of reading data from an array of independent disk drives so as to provide synchronous data transfer into a buffer, the method comprising:
for each disk drive in the array, providing a corresponding two-port memory for receiving and storing read data responsive to timing signals provided by the respective drive;
initiating a READ command to each of the drives of the array, thereby causing each of the drives to retrieve selected elements of its stored data, and to transfer the retrieved data from the drive into the corresponding two-port memory using the timing signals provided by the respective drive;
monitoring each of the two-port memories to detect a non-empty condition, implying receipt of transferred data in the memory from the corresponding disk drive;
waiting until all of the two-port memories indicate such a non-empty condition;
then synchronously reading the stored data from all of the two-port memories, thereby forming synchronous read data, and writing the synchronous read data into the buffer; and
repeating said monitoring, waiting; reading and writing into the buffer steps until completion of a read operation initiated by the said READ command.

2. A method of reading data according to claim 1 wherein:
the stored data includes user data as well as redundant data sufficient to enable reconstruction of all of the user data in the event of a failure of any single drive of the array and the method further comprising,
in the event that one of the disk drives fails, executing said initiating, monitoring, waiting and synchronously reading steps only with respect to the non-failed drives; and
regenerating missing data corresponding to the failed drive “on the fly” from the synchronous read data.

3. A method of reading data from an array according to claim 1 wherein each two-port memory comprises a FIFO memory.

4. A method of reading data from an array according to claim 3 wherein the array comprises a redundant array.

5. A method of reading data from an array according to claim 4 and further comprising regenerating data “on the fly” in the event that one of the disk drives has failed.

6. A method of reading data from an array according to claim 1 wherein the read operation is effected via a UDMA interface to at least one of the disk drives.

7. A method of reading data from an array according to claim 1 wherein the read operation is effected via a corresponding UDMA interface to each of the disk drives.

8. A method of reading data from an array according to claim 1 wherein said synchronously reading the stored data from all of the two-port memories comprises asserting a common read enable signal to the memories.

9. A method of reading data from an array according to claim 1 wherein said synchronously reading the stored data from all of the two-port memories is conducted over a single DMA channel.

10. A method of reading data from a redundant array of independent disk drives comprising:
for each disk drive in the redundant array, providing a corresponding FIFO memory arranged for receiving and storing read data using timing signals provided by the respective drive;
initiating a READ command to each of the drives of the RAID array, thereby causing each of the drives to retrieve selected elements of its stored data, and to transfer the retrieved data from the drive into the corresponding FIFO memory using the timing signals provided by the respective drive;
monitoring each of the FIFO memories to detect a non-empty condition, implying receipt of data in the FIFO memory from the corresponding disk drive;
waiting until all of the FIFO memories indicate such a non-empty condition;
then synchronously reading the stored data from all of the FIFO memories, thereby forming synchronous read data;
writing the synchronous read data into a common buffer; and
repeating said monitoring, waiting, reading and writing steps until completion of a read operation initiated by the READ command.

11. A method of reading data according to claim 10 wherein the data is word striped over the redundant array.

12. A method of reading data according to claim 10 and further comprising, in the event that one of the disk drives fails to provide read data to its associated FIFO memory, regenerating the missing data “on the fly” from the synchronous read data.

13. A method of reading data according to claim 10 wherein each of the drives is coupled to its associated FIFO memory via a UDMA interface.

14. A method of reading data according to claim 10 wherein the synchronous transfer of read data into the common buffer is implemented with a single address counter and a common FIFO read enable signal.

15. A method of reading data from an array according to claim 10 wherein each synchronous transfer of read data into the common buffer stores 64-bits of read data.

16. A method of reading data from an array according to claim 10 and further comprising providing a FIFO memory in the data path between the individual drive FIFO memories and the common buffer.

17. An improved RAID disk array controller comprising:
a plurality of disk drive interfaces for attaching physical disk drives;
a two-port memory associated with each of the disk drive interfaces, each two-port memory arranged to store read data provided by the associated disk drive in a disk read operation and, conversely, to provide write data that was previously-stored in the memory to the associated disk drive in a disk write operation;
a logic circuit coupled to all of the two-port memories for detecting when all of the two-port memories have data stored therein for a read operation or available space therein for a write operation;
control circuitry responsive to the logic circuit for synchronously reading data from all of the two-port memories only when all of the two-port memories have data stored therein, thereby forming synchronous read data;
the control circuitry further responsive to the logic circuit for detecting that all of the two-port memories have space therein and synchronously writing data to all of the two port memories thereby forming synchronous write data;
first redundant data circuitry for regenerating missing data “on the fly” from the synchronous read data in the event that one of the disk drives fails to provide read data to its associated two-port memory in a read operation; and
second redundant data circuitry for generating redundant data “on the fly” from the synchronous write data for storing in the array.

18. An improved RAID disk array controller according to claim 17 and wherein each two-port memory has multiplexers for exchanging its input and output ports depending on the data transfer direction.

19. An improved RAID disk array controller according to claim 17 wherein each two-port memory comprises a FIFO memory.

20. An improved RAID disk array controller according to claim 17 wherein the common buffer comprises DRAM.

21. An improved RAID disk array controller according to claim 17 and further comprising a single address counter arranged for addressing the buffer for transfers between the buffer and the FIFO memories in either direction.

22. An improved disk array controller according to claim 17 wherein at least one disk drive interface implements a ATA/ATAPI protocol.

23. An improved disk array controller according to claim 17 wherein all of the disk drive interfaces implement a ATA/ATAPI protocol.

24. An improved disk array controller according to claim 17, implemented on a motherboard.

25. An improved disk array controller according to claim 17, implemented on a Host Bus Adapter.

26. A method of writing data into an array of independent disk drives, the method comprising:
providing a buffer for storing write data;
for each disk drive in the array, providing a corresponding two-port memory for receiving and storing write data, the two-port memory;
monitoring each of the two-port memories to detect a non-full condition;
waiting until all of the two-port memories indicate such a non-full condition;
then reading write data from the buffer;
computing redundant data from said write data;
synchronously storing the write data and the redundant data into the two-port memories via a first port of each memory; and
substantially concurrently, transferring stored data from a second port of each of the two-port memories into the corresponding disk drives, in each case transferring the data responsive to timing control provided by the respective disk drive.

27. A method of storing data into an array according to claim 26 and further comprising stalling said storing step whenever any of the two-port memories becomes full, but only with regard to the full memory, while allowing said synchronously storing the write data to continue into the non-full two-port memories.

28. A method of storing data into an array according to claim 27 wherein each two-port memory comprises a FIFO memory.

29. A method of storing data into an array according to claim 28 wherein the write operation is effected via a UDMA interface to at least one of the disk drives.

30. A method of storing data into an array according to claim 28 wherein the write operation is effected via a corresponding UDMA interface to each of the disk drives.

31. A method of storing data into an array according to claim 27 wherein said synchronously storing the write data into the FIFOs comprises asserting a common write strobe coupled to all of the FIFO memories.
